(19) United States
(12) Patent Application Publication
(10) Pub. No.: US 2008/0284134 A1
(43) Pub. Date: Nov. 20, 2008

(54) TOW HITCH HOOK AND METHOD OF USE

(75) Inventor: Robert Temple, Apache Junction, AZ (US)

Correspondence Address: SCHMEISER OLSEN & WATTS, 18 E UNIVERSITY DRIVE, SUITE # 101, MESA, AZ, 85201, US

(73) Assignee: Dorian David Temple, Mesa, AZ (US)

(21) Appl. No.: 12/120,477

(22) Filed: May 14, 2008

Related U.S. Application Data
(60) Provisional application No. 60/917,890, filed on May 14, 2007.

(51) Int. Cl. B60D 1/04

(52) U.S. Cl. 280/495

(57) ABSTRACT

A tow hook configured according to an embodiment of the present invention comprising: at least two hooks wherein each hook comprises a shank, a hook and an axis; a main shaft further comprising an inside surface and an axis, wherein the shanks of the at least two hooks are permanently coupled to the inside surface of the main shaft; wherein at least one cross rod is coupled to the shanks of the at least two hooks and the main shaft, wherein the axis of the at least one cross rod is perpendicular to the axis of the at least two hooks and the axis of the main shaft; at least one centering rod comprising an axis, wherein the axis is parallel to the axis of the at least two hooks and the axis of the main shaft; and wherein the main shaft is configured to couple to a vehicle.

### CROSS-REFERENCE TO RELATED APPLICATIONS

This patent application claims priority to U.S. Provisional Application No. 60/917,890 filed in May 14, 2007, the contents of which are incorporated herein by reference.

### BACKGROUND OF THE INVENTION

1. Technical Field

This invention relates to a hooked tow hitch for towing vehicles.

2. Background Art

While participating in the recreational activity of four-wheeling, vehicles often get stuck in mud, snow, or other natural or artificial entrapments. Stuck vehicles are a problem because the purpose of the sport involves movement through mud, snow, or other natural or artificial mediums, and a stuck vehicle is normally not able to move on its own power. Vehicles also get stuck while engaged in activities other than recreational ones. Emergency vehicles could become stuck in mud while trying to rescue people during a heavy rainstorm. Snow removal vehicles could become stuck in snow while trying to clear snow off of a road. Many other situations are conceivable in which vehicles could get stuck.

Because vehicles could frequently get stuck, manufacturers of trucks and other vehicles suited to off-road transport now integrate tow hooks into the build of the vehicle. The hooks are usually located below the bumper on the front of the truck. Generally, if a truck is used to tow another vehicle out of mud or snow, the driver connects a rope, chain, or cable to a tow hook on the front of the towing vehicle and drives backward, thus pulling the immobile vehicle to freedom. Previously, the standard tow hooks found on a vehicle were the most convenient and effective method to tow other, stuck, vehicles.

However, standard tow hooks have several problems. Generally standard tow hooks consist of a single upright hook. Because the hook is shaped to allow easy connection with a tow rope or strap, it also allows the tow rope to easily fall off the tow hook, especially when the towing vehicle is at a tight angle or higher elevation relative to the stuck vehicle, and when the tow rope is not taut. Because the type of terrain where vehicles can often get stuck is usually uneven, inadvertent unhooking of the tow rope is a common problem. Each occurrence of this problem greatly inconveniences the driver, wastes time, and causes the driver to have to get out of the vehicle and walk repeated times through the mud, snow, and the like to reconnect the tow hook, thus increasing danger of injury, frostbite, and the like.

Another problem with standard tow hooks is that they are generally constructed into the front of the towing vehicle, which means that the towing vehicle will have to drive backwards as it tows other vehicles. This can not only be inconvenient and uncomfortable to the driver, but increases the danger of running over pedestrians because of decreased visibility.

Accordingly, what is needed is a tow hook which can be attached to already-existing vehicles that solves the problem of the tow rope or strap inadvertently disconnecting from the towing vehicle.

### DISCLOSURE OF THE INVENTION

The present invention may be readily and easily adapted to a variety of off-road and towing-capable vehicles. Embodiments of the present invention may provide, among other benefits: a way to tow stuck vehicles without the tow rope or strap falling off of the tow hook and towing other vehicles while driving forward. This may reduce the inconvenience associated with tow ropes or straps falling off standard tow hooks and with driving backward while towing.

In particular embodiments, a tow hitch hook configured according to an embodiment of the present invention comprises at least two hooks wherein each hook comprises a shank, a hook and an axis; wherein the at least two hooks are coupled along the shanks in symmetrical alignment; a main shaft further comprising an outside surface, an inside surface and an axis, wherein the shanks of the at least two hooks are permanently coupled to the inside surface of the main shaft with the hooks of the at least two hooks curving away from each other; at least one cross rod comprising an axis, wherein the at least one cross rod is coupled to the shanks of the at least two hooks and the main shaft, wherein the axis of the at least one cross rod is perpendicular to the axis of the at least two hooks and the axis of the main shaft; at least one centering rod comprising an axis, wherein the axis of the at least one centering rod is parallel to the axis of the at least two hooks and the axis of the main shaft; wherein the at least one centering rod is coupled to the shanks of the at least tow hooks and the inside surface of the main shaft; wherein the main shaft is configured to couple to a trailer hitch of a vehicle; and wherein the main shaft further comprises at least one hitch receiver pin hole.

The foregoing and other features and advantages of the invention will be apparent to those of ordinary skill in the art from the following more particular description of the invention and the accompanying Figures.

### BRIEF DESCRIPTION OF THE DRAWINGS

The invention will hereinafter be described in conjunction with the appended figures:

FIG. 1 is a top view of a tow hitch hook configured according to an embodiment of the present invention with two hooks;

FIG. 2 is a side view of a tow hitch hook configured according to an embodiment of the present invention with two hooks and one hitch receiver pin hole;

FIG. 3 is a view of the attachment of the hooks to the main shaft according to an embodiment of the present invention;

FIG. 4 is a side view of a tow hitch hook configured according to a third embodiment of the present invention with two hooks and two hitch receiver pin holes; and

FIG. 5 is a cross section of a tow hitch hook as shown in FIG. 4.

### DESCRIPTION OF THE INVENTION

As discussed above, embodiments of the present invention relate to tow hitch hooks. Generally, a tow hitch hook configured according to an embodiment of the present invention may include more than one hook attached to a vehicle.

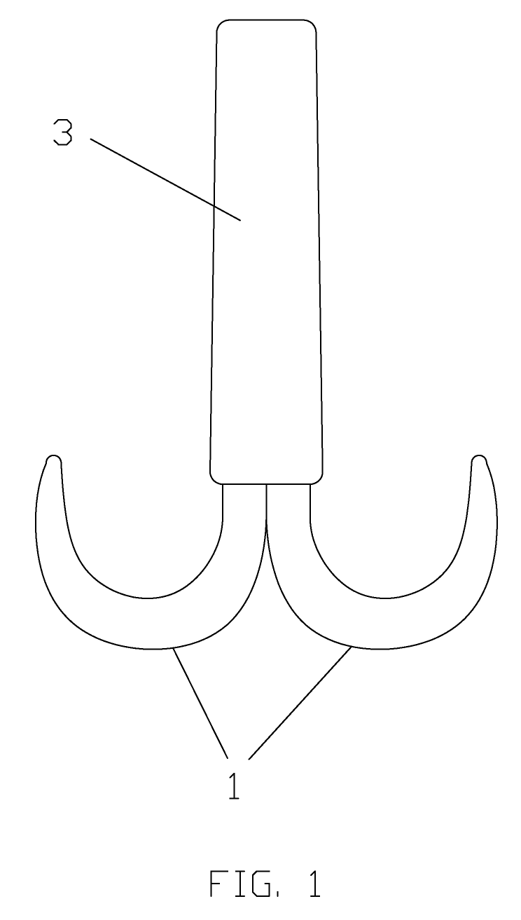

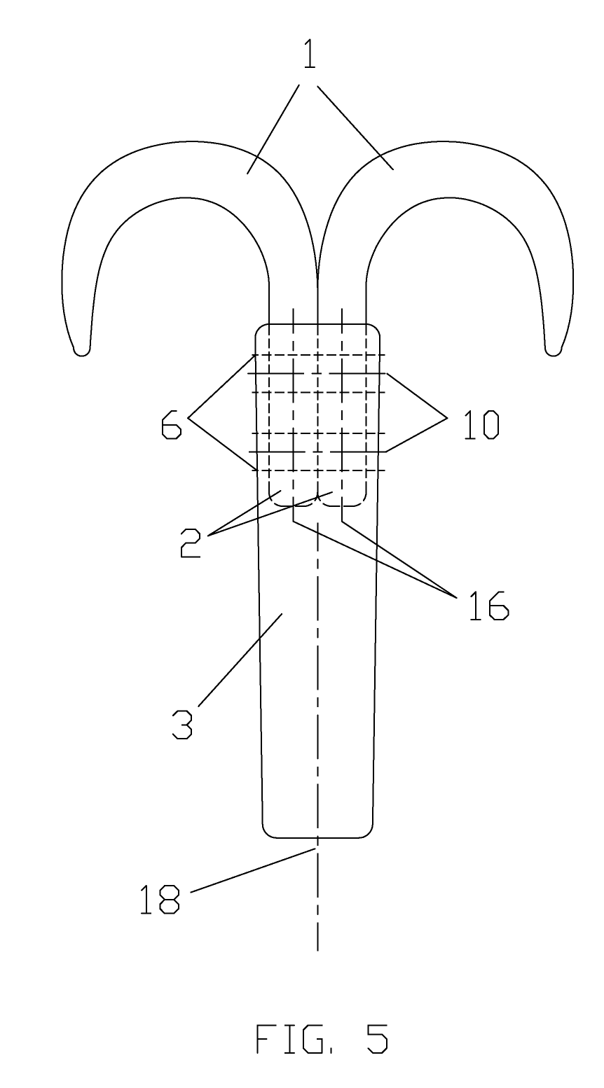

FIGS. 1-5 illustrate a tow hitch hook configured according to two embodiments of the present invention. One embodiment of the present invention comprises two hooks 1, connected to each other along the shank 2 of each hook, so that each hook 1 is curving away from the other hook 1. Each hook 1 has an axis 16 (see FIG. 5) that defines the center of the shank 2. In the embodiment of the present invention, the hooks 1 are rounded hooks. In an alternate embodiment, the hooks are angled hooks. In yet another embodiment, the hooks have a spring-loaded gate that can better secure the tow rope, strap, chain, cable, or other similar means of towing. The shape of the hooks used in the invention could be any shape that is capable of securing a tow rope, strap, chain, cable, or other similar means of towing. FIG. 1 illustrates one embodiment of the present invention, which has two hooks 1 that are attached to each other by welding all along the shank 2 of each; with each hook 1 curving in opposite directions but still lying in the same plain. The shank 2 of each hook is cylindrical. The hooks 1 are welded along the entire shank 2 to ensure sufficient strength for towing. In other embodiments of the present invention, the hooks are fused or connected together by any method strong enough for the task of towing. Alternate embodiments of the present invention have any number of hooks more than one fused together and spaced radially symmetrical from one another. In alternate embodiments, any number of hooks may be positioned asymmetrically, but are still positioned in a manner which allows a tow rope, strap, chain, cable, or other similar means of towing to be secured to the invention.

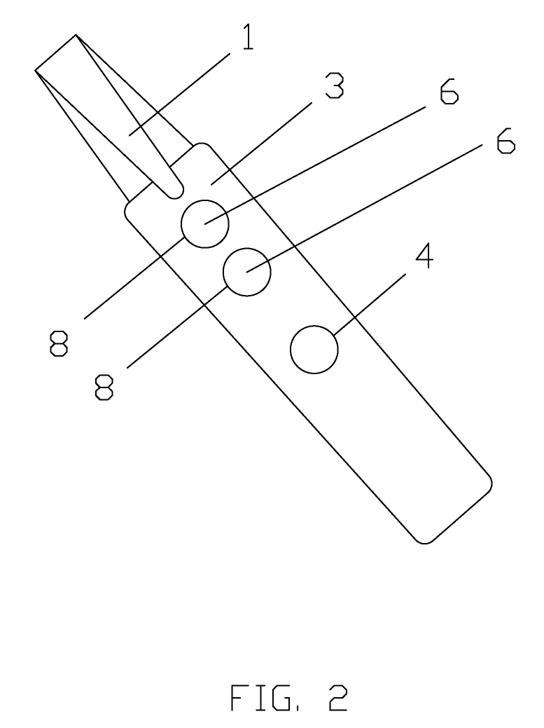

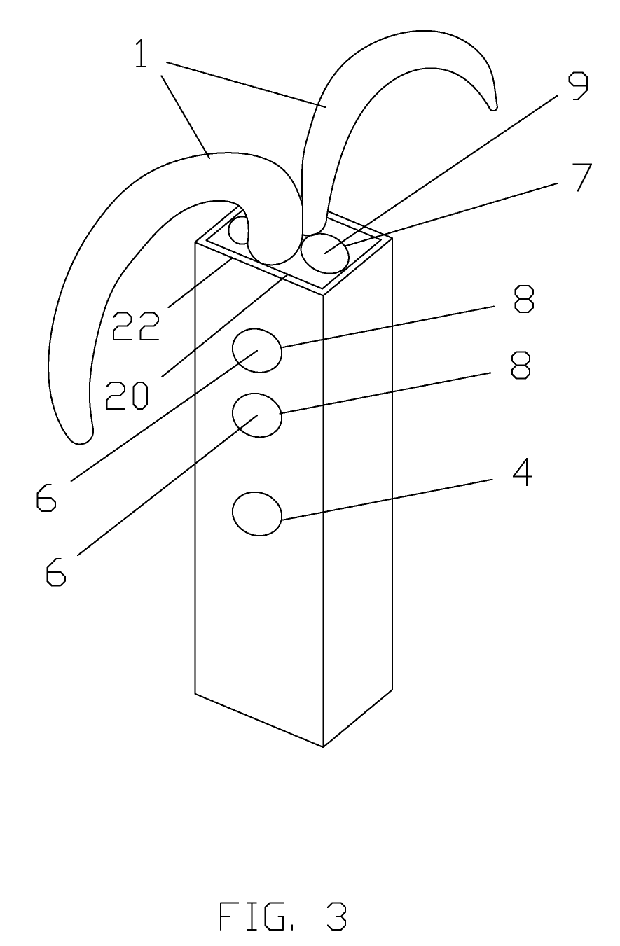

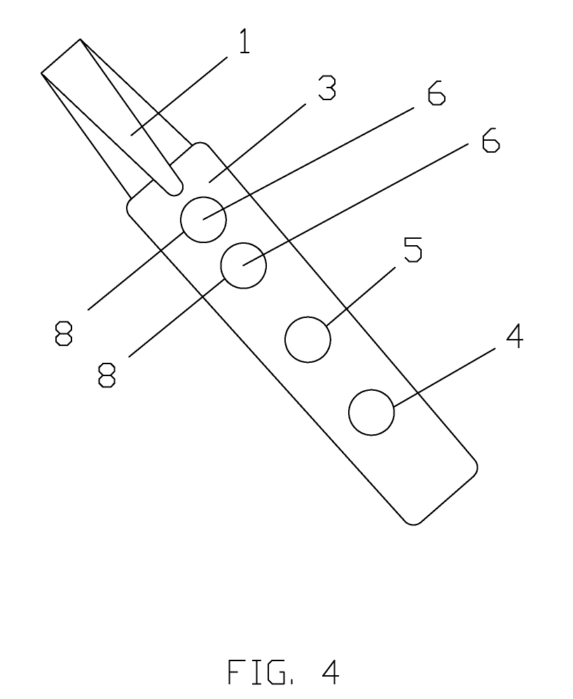

Embodiments of the present invention comprise a main shaft 3, which is welded or otherwise fused or connected to the multiplicity of hooks 1. The main shaft 3 is hollow, which allows the hooks 1 to be welded or otherwise fused or connected to an inside surface 20 of the shaft 3. If the main shaft 3 is hollow, it has an inside surface 20 and an outside surface 22 (see FIG. 3). In alternate embodiments, the shaft 3 is solid, in which case the shaft 3 is welded or otherwise fused or connected to the hooks in a different manner. In the first embodiment, the shaft 3 is shaped so as to fit into a trailer hitch receiver common to many currently existing vehicles. A cross section (see FIG. 5) of the shaft 3 is shaped like a square with rounded corners having an axis 18. In alternate embodiments, the main shaft 3 is not necessarily the suitable size and shape so as to fit into a trailer hitch receiver. It is the size and shape necessary to mount directly to any part of a vehicle, such as a vehicle frame or bumper, as long as the part of the vehicle to which the shaft is connected is sufficiently strong for the task of towing. FIG. 2 illustrates one embodiment of the present invention which has one hitch receiver pin hole 4 on the side of the main shaft positioned such that a receiver pin can be placed in the hole 4 to secure the shaft 3 to the hitch receiver. The receiver pin hole 4 is the standard size and location for hitch receiver pins, common to the use of trailer hitches. FIG. 4 illustrates an alternate embodiment of the present invention which has two holes 4, 5 on the side of the main shaft 3 positioned such that a hitch receiver pin can be placed in either hole 4, 5. Two receiver pin holes 4, 5 gives the user more flexibility, so that if the user's towing vehicle's hitch receiver is shorter than the standard length, the receiver pin hole 4 farthest from the hooks 1 can be used, and if the hitch receiver is longer, the receiver pin hole 5 closest to the hooks can be used. In other alternate embodiments which are designed to be used in conjunction with the towing vehicle's hitch receiver, the shaft can have any number of receiver pin holes. The receiver pin holes are placed anywhere on the embodiment as long as the position of the receiver pin hole allows the receiver pin to fit into the receiver pin hole, and as long as the position allows the embodiment to be strong enough for the task of towing.

As illustrated in FIG. 5, the embodiment of the present invention comprises one or more cross rods 6 for structural strengthening of the embodiment. The cross rods 6 are cylinders with axis 10 that run down the center of the cross rods 6, or any suitable shape, with the length roughly equal to the width of the main shaft 3. The cross rods 6 are embedded in holes drilled through the main shaft 3 and hook shanks 2. The cross rods 6 welded or otherwise fused or connected to the main shaft 3 to maintain structural integrity when towing heavy loads. FIG. 2 indicates the location of the holes 8 where the cross rods 6 are embedded. The cross rods 6 are in a position such that their axes are parallel to each other and perpendicular to the axes of both the main shaft 3 and the hook shanks 2.

The embodiment of the present invention comprises one or more centering rods 7, which are welded inside the main shaft 3 between the hook shanks 2 of each hook and the inside wall of the main shaft 3. The centering rods 7 are positioned so as to prevent the hook shanks 2 from moving side to side in relation to the main shaft 3 and in relation to the other hook shank 2 while towing heavy loads. The centering rods 7 are oriented so that the axes 9 of the centering rods 7 are parallel to the axes 18 of the main shaft 3 and the axes 16 of the hook shanks 2 and perpendicular to the axes 10 of the cross rods 6. The centering rods 7 are welded to both the inside surface 20 of the main shaft 3 and the hook shanks 2. Alternate arrangements of the centering rods are also envisioned.

Embodiments of the invention are shaped and sized such that it fits into a trailer hitch receiver common to many vehicles, The main shaft 3 is inserted into the trailer hitch receiver in such a way that the axis of the main shaft 3 and the axis 16 of each hook 1 is perpendicular to the vehicle bumper. Alternate embodiments of the present invention attach to the towing vehicle by different ways than into a hitch receiver. For example, the main shaft of an alternate embodiment is welded or otherwise fused or connected directly to the frame of the towing vehicle, or directly to the bumper of the towing vehicle in such a manner that the embodiment is secured sufficiently for the task of towing. In the embodiment of the present invention, the main shaft 3 is connected to the towing vehicle in such a manner that the hooks 1 extend horizontally away from the towing vehicle and the hitch receiver pin hole 5 on the embodiment lines up with the pin hole on the towing vehicle's hitch receiver.

The embodiment of the present invention could be connected with a tow rope, strap, chain, cable, or other similar means of towing in a number of manners. The tow rope, strap, chain, cable, or other similar means of towing could be wrapped around the hooks 1 in a figure-eight or other similar pattern. The end of the tow rope, strap, chain, cable, or other similar means of towing could then be secured on the embodiment by tying or otherwise attaching to the hooks 1. A tow strap loop could be secured around both hooks 1, with the tow strap extending either above or below the hooks 1. The tow rope, strap, chain, cable, or other similar means of towing could be connected to the embodiment using other ways, as long as the connection is secure enough for the task of towing. The end of the tow rope, strap, chain, cable, or other similar means of towing which will be connected with the vehicle or object being towed can be hung between the hooks 1 before the towing begins.

Accordingly, for the exemplary purposes of this disclosure, the components defining any embodiment of the invention may be formed as one piece if it is possible for the components to still serve their function. Alternatively, the entire embodiment may be cast in one single piece. The components may also be composed of any of many different types of materials or combinations thereof that can readily be formed into shaped objects provided that the components selected are consistent with the intended mechanical operation of the invention. For example, the components may be formed of composites such as fiberglass, carbon-fiber and/or other like materials, polymers such as plastic, polycarbonate, PVC plastic, ABS plastic, acrylic, nylon, phenolic, any combination thereof, and/or other like materials, metals, such as zinc, magnesium, titanium, copper, iron, steel, stainless steel, any combination thereof, and/or other like materials, alloys, such as aluminum, and/or other like materials, any other suitable material, and/or any combination thereof. One requirement for the material is that the material must be sufficiently strong enough for the task of towing. Additionally, any embodiment or any components defining any embodiment of the invention may be covered, plated, coated, painted, or otherwise finished in a wide variety of materials: composites such as fiberglass, carbon-fiber and/or other like materials, polymers such as plastic, polycarbonate, PVC plastic, ABS plastic, acrylic, nylon, phenolic, any combination thereof, and/or other like materials, metals, such as zinc, magnesium, titanium, copper, iron, steel, stainless steel, any combination thereof, and/or other like materials, alloys, such as aluminum, and/or other like materials, any other suitable material, and/or any combination thereof, or powder coating.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation.

1. A tow hook configured according to an embodiment of the present invention comprising:
at least two hooks wherein each hook comprises a shank, a hook and an axis;
a main shaft further comprising an outside surface, an inside surface and an axis, wherein the shanks of the at least two hooks are permanently coupled to the inside surface of the main shaft with the hooks of the at least two hooks curving away from each other;
at least one cross rod comprising an axis, wherein the at least one cross rod is coupled to the shanks of the at least two hooks and the main shaft, wherein the axis of the at least one cross rod is perpendicular to the axis of the at least two hooks and the axis of the main shaft;
at least one centering rod comprising an axis, wherein the axis of the at least one centering rod is parallel to the axis of the at least two hooks and the axis of the main shaft; and
wherein the main shaft is configured to couple to a vehicle.

2. The tow hook of claim 1, wherein the main shaft is configured to couple to a trailer hitch on a vehicle.

3. The tow hook of claim 1, wherein the main shaft further comprises at least one hitch receiver pin hole.

4. The tow hook of claim 1, wherein the at least one centering rod is welded between the shanks of the at least two hooks and the inside wall of the main shaft.

5. The tow hook of claim 1, wherein the at least one cross rod is embedded in holes drilled through the main shaft and shanks of the at least two hooks.

6. The tow hook of claim 1, wherein the at least two hooks are coupled together along their shanks.

7. The tow hook of claim 1, wherein the main shaft is configured to couple to any part of a vehicle.

8. A tow hook configured according to an embodiment of the present invention comprising:
at least two hooks;
a main shaft further comprising an inside surface, wherein the at least two hooks are permanently coupled to the inside surface of the main shaft,
at least one cross rod is coupled to the at least two hooks and the main shaft;
at least one centering rod; and
wherein the main shaft is configured to couple to a vehicle.

9. The tow hook of claim 8, wherein the main shaft is configured to couple to a trailer hitch of a vehicle.

10. The tow hook of claim 8, wherein the at least one cross rod is perpendicular to the main shaft and the at least two hooks.

11. The tow hook of claim 8, wherein the at least one centering rod is parallel to the main shaft and the at least two hooks.

12. The tow hook of claim 8, wherein hooks of the at least two hooks are aligned symmetrically.

13. The tow hook of claim 8, wherein the at least two hooks extend horizontally away from the vehicle.

14. A tow hitch hook configured according to an embodiment of the present invention comprising:
at least two hooks wherein each hook comprises a shank, a hook and an axis;
wherein the at least two hooks are coupled along the shanks in symmetrical alignment;
a main shaft further comprising an outside surface, an inside surface and an axis, wherein the shanks of the at least two hooks are permanently coupled to the inside surface of the main shaft with the hooks of the at least two hooks curving away from each other;
at least one cross rod comprising an axis, wherein the at least one cross rod is coupled to the shanks of the at least two hooks and the main shaft, wherein the axis of the at least one cross rod is perpendicular to the axis of the at least two hooks and the axis of the main shaft;
at least one centering rod comprising an axis, wherein the axis of the at least one centering rod is parallel to the axis of the at least two hooks and the axis of the main shaft;
wherein the at least one centering rod is coupled to the shanks of the at least tow hooks and the inside surface of the main shaft;
wherein the main shaft is configured to couple to a trailer hitch of a vehicle; and
wherein the main shaft further comprises at least one hitch receiver pin hole.

15. The tow hitch hook of claim 14, wherein the main shaft further comprises at least two hitch receiver pin holes in order to allow the tow hitch hook to couple to different lengths of trailer hitches.

16. The tow hitch hook of claim 14, wherein the at least one cross rod is embedded in holes drilled through the main shaft and the shanks of the at least two hooks.

17. The tow hitch hook of claim 14, wherein the main shaft is has a square cross section.

18. The tow hitch hook of claim 14, further comprising three hooks oriented symmetrically.

19. The tow hitch hook of claim 14, further comprising at least two hooks oriented asymmetrically.

20. The tow hitch hook of claim 14, wherein the at least two hooks are welded together.
